(19) United States
(12) Patent Application Publication
(10) Pub. No.: US 2011/0154967 A1
(43) Pub. Date: Jun. 30, 2011

(54) Riving knife adjustment mechanism for a saw machine

(75) Inventor: Cheng-Hung CHIU, Taichung (TW)

(73) Assignee: REXON INDUSTRIAL CORP., LTD., Taichung (TW)

(21) Appl. No.: 12/974,514

(22) Filed: Dec. 21, 2010

(30) Foreign Application Priority Data
Dec. 30, 2009 (TW) 098145853

(51) Int. Cl. B27G 19/08

(52) U.S. Cl. 83/102.1

(57) ABSTRACT

A riving knife adjustment mechanism includes a locating member and an operating member. The locating member also includes a locking member movable relative to the riving knife to lock or unlock the riving knife, and a connection portion connected with the locking member. The operating member has a coupling portion set inside the machine base and connected with the connection portion, and an operating portion operatively connected to the coupling portion and extending out of the machine base for manipulation by an operator to move the locking member for quick adjustment of the riving knife.

This application claims, under 35 U.S.C. §119, priority to Taiwanese Application No. 098145853, filed Dec. 30, 2009, which application is hereby incorporated by reference in its entirety, inclusive of the specification, claims, and drawings.

### FIELD OF THE INVENTION

The present disclosure relates to a saw machine and more particularly, to a riving knife adjustment mechanism for a saw machine.

### BACKGROUND

A saw machine has safety devices to protect the operator from injury.

For example, a riving knife may be fixedly mounted on the machine base behind the saw blade to prevent a phenomenon known as kickback, which occurs when the wood being cut is caught by the rear edge of the saw blade, lifted off the table, and propelled backwards toward the operator.

Such safety devices typically require adjustment. In particular, when changing out different sizes of saw blades for cutting different thickness of wooden materials, or when switching out different saw blades used for different working conditions, the height of the saw blade may have to be adjusted up and down. In such a case, the riving knife may also have to be adjusted subject to the adjusted position of the saw blade. Therefore, it is a desired function of a saw machine to allow quick mounting, dismounting and adjustment of the riving knife.

U.S. Pat. No. 6,840,144 B2 discloses a riving knife mounting structure, as reproduced in FIG. 1, which includes a control plate 1 having a sloping face 102, and which is movable to control a spring-loaded pin 2, causing the spring-loaded pin 2 to engage with a retaining hole 301 on a riving knife 3 or to move away from the retaining hole 301. Thus, the riving knife 3 can be vertically adjusted or detached from the machine for replacement.

Additionally, U.S. Pat. No. 7,437,981 B2, Taiwan Patent No. TW I305160 and TW M280905 also disclose quick-detachable, quick-adjustable riving knife mounting structures.

The structure disclosed in U.S. Pat. No. 6,840,144 B2 (as shown in FIG. 1) allows for quick adjustment or replacement of the riving knife 3 on a mounting frame 4. However, when adjusting or replacing the riving knife 3, the operator must insert a hand into the inside of the machine base of the saw machine (not shown) to operate the control plate 1 within a narrow space. As such, it is inconvenient to operate this structure. U.S. Pat. No. 7,437,981 B2, Taiwan Patent No. TW 1305160 and TW M280905 also disclose structures that have the same problem.

### SUMMARY

The present disclosure has been accomplished under the circumstances in view. Accordingly, embodiments of the present disclosure provide a riving knife adjustment mechanism for a saw machine, which is easy to operate and allows for quick adjustment.

In particular, a riving knife adjustment mechanism is mounted with a locating member in a machine base of a saw machine having a top wall. The riving knife adjustment mechanism is provided in order to adjustably and selectively lock and hold a riving knife. The riving knife adjustment mechanism includes a locking unit and an operating member. The locking unit is disposed below the top wall of the machine base and is installed on the locating member. The locking unit includes a locking member rotatable to lock or release the riving knife. The locking member includes a coupling mechanism disposed inside the machine base. An operating member includes a connection portion coupled to the coupling mechanism of the locking member, and an operating portion extending from the connection portion and suspended outside the machine base.

Embodiments of a riving knife adjustment mechanism according to the present disclosure have the effects that the grip of the operating portion of the operating member is disposed outside of the machine base for convenient operation by a user, such that when the grip of the operating portion of the operating member is manipulated, the locking unit is moved via the coupling arrangement between the connection portion of the operating member and the coupling mechanism of the locking unit, in order to lock or release the riving knife, thus facilitating quick adjustment of the riving knife.

### BRIEF DESCRIPTION OF THE DRAWINGS

FIG. 1 is an exploded view of a riving knife adjustment structure according to the prior art.

FIG. 2 is an exploded view of a riving knife adjustment mechanism for a saw machine in accordance with a first embodiment of the present disclosure.

FIG. 3 is a plain assembly view of the riving knife adjustment mechanism in accordance with the first embodiment of the present disclosure, illustrating the riving knife in the highest position relative to the locating member.

FIG. 4 is a sectional view taken along line IV-IV of FIG. 3, illustrating the retaining portion of the riving knife in a locking position.

FIG. 5 is similar to FIG. 3 but illustrating the riving knife in the lowest position relative to the locating member.

FIG. 6 is similar to FIG. 4 but illustrating the retaining portion of the riving knife in an unlocking position.

FIG. 7 is an assembly view of a riving knife adjustment mechanism in accordance with a second embodiment of the present disclosure.

### DETAILED DESCRIPTION

Other and further advantages and features of the disclosure will be understood by reference to the following specification in conjunction with the accompanying drawings, in which like reference signs denote like elements of structure.

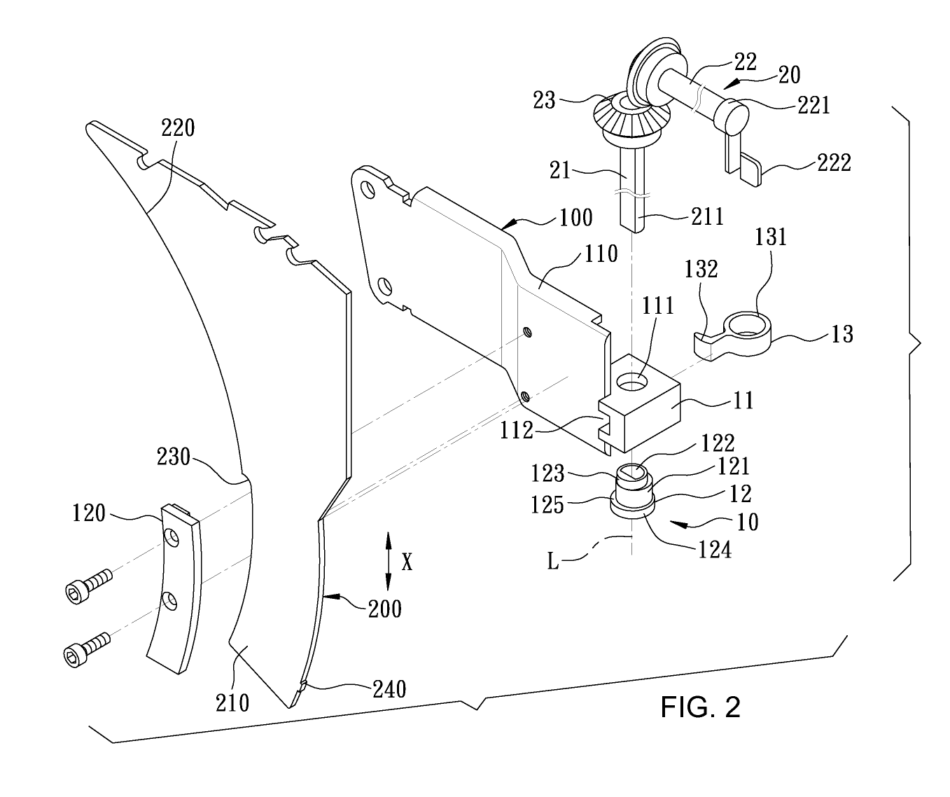

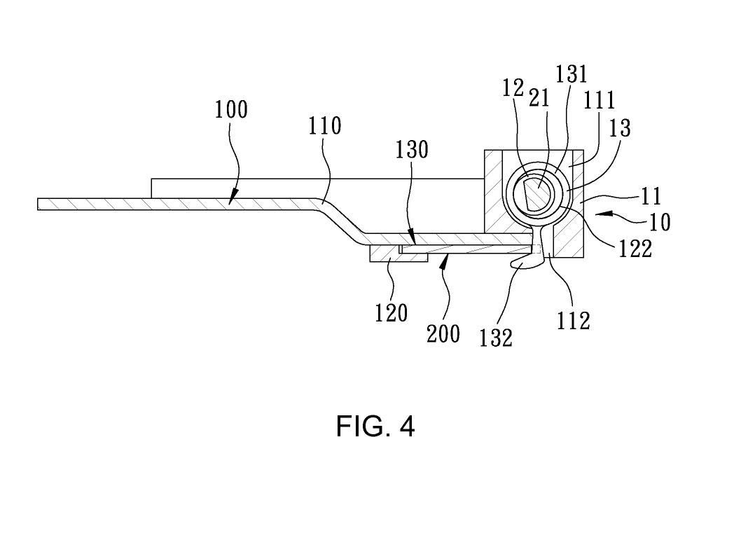

Referring to FIGS. 2, 3 and 4, a riving knife adjustment mechanism for a saw machine in accordance with the present disclosure is shown including a riving knife 200 installed in a machine base 300 by use of a locating member 100. The machine base 300 has a top wall 310. The locating member 100 is fixedly mounted to a saw blade holder (not shown) on the inside of the machine base 300 below the top wall 310, and includes a body base 110 and a limiter block 120 that has an inverted L-shape cross section (see FIG. 4).

The riving knife 200 includes a coupling portion 210 slidably inserted into the space between the body base 110 of locating member 100 and the limiter block 120, and a riving knife body 220 connected to one end of the coupling portion 210 corresponding to the top wall 310. The coupling portion 210 includes an upper limit stop 230 disposed at a first lateral side thereof and adjacent to the riving knife body 220, and a lower limit stop 240 disposed at a second lateral side thereof remotely spaced from the riving knife body 220. The riving knife adjustment mechanism further includes a locking unit 10 and an operating member 20.

The locking unit 10 is disposed below the top wall 310 of the machine base 300 and is mounted to the locating member 100, and includes an axle holder 11 affixed to a first lateral side of the body base 110 of the locating member 100, a brake 12 mounted in the axle holder 11, and a locking member 13 movable by the brake 12.

The axle holder 11 and the limiter block 120 define therebetween a track 130 for respectively engaging the two opposite side edges of the riving knife 200 to prohibit the riving knife 200 from lateral displacement. The axle holder 11 includes an axle hole 111 extending along an axis L corresponding to the longitudinal direction X, and an opening 112 extending through the axle hole 111 and the track 130.

The brake 12 includes a cylindrical brake portion 121 disposed in an eccentric manner relative to the axis L, a noncircular coupling mechanism, for example, coupling hole 122, extending along the axis L, a first end portion 123 extending along the axis L at a first end of the cylindrical brake portion 121 and inserted into the axle hole 111, a second end portion 124 extending along the axis L at an opposed second end of the cylindrical brake portion 121 and inserted into the axle hole 111, and a shoulder 125 between the cylindrical brake portion 121 and the second end portion 124. The noncircular coupling hole 122 extends through the first end portion 123 and the second end portion 124.

The locking member 13 includes a collar 131 arranged on the cylindrical brake portion 221, and a retaining portion 132 extending from the periphery of the collar 131. The collar 131 is blocked at and rests upon the shoulder 125. The retaining portion 132 extends through the opening 112 of the axle holder 11 into the track 130.

The operating member 20 includes a first shaft 21 inserted through the coupling hole 122, a second shaft 22 arranged in a right-angle manner relative to the first shaft 21 and a transmission gear set 23 (two meshed bevel gears) positioned between the first shaft 21 and the second shaft 22. The first shaft 21 has a connection portion 211 disposed at one end thereof. The connection portion 211 has a noncircular cross section (the shape of a segment of a circle) corresponding to the cross section of the noncircular coupling hole 122. The second shaft 22 includes an operating portion 221 extending through and out of the machine base 300 and terminating in a grip 222. Due to the design of the corresponding noncircular shape (segment of a circle) of the first shaft 21 and the coupling hole 122, the locating member 100 and the locking unit 10 can be moved along the axis L relative to the top wall 310 of the machine base 300.

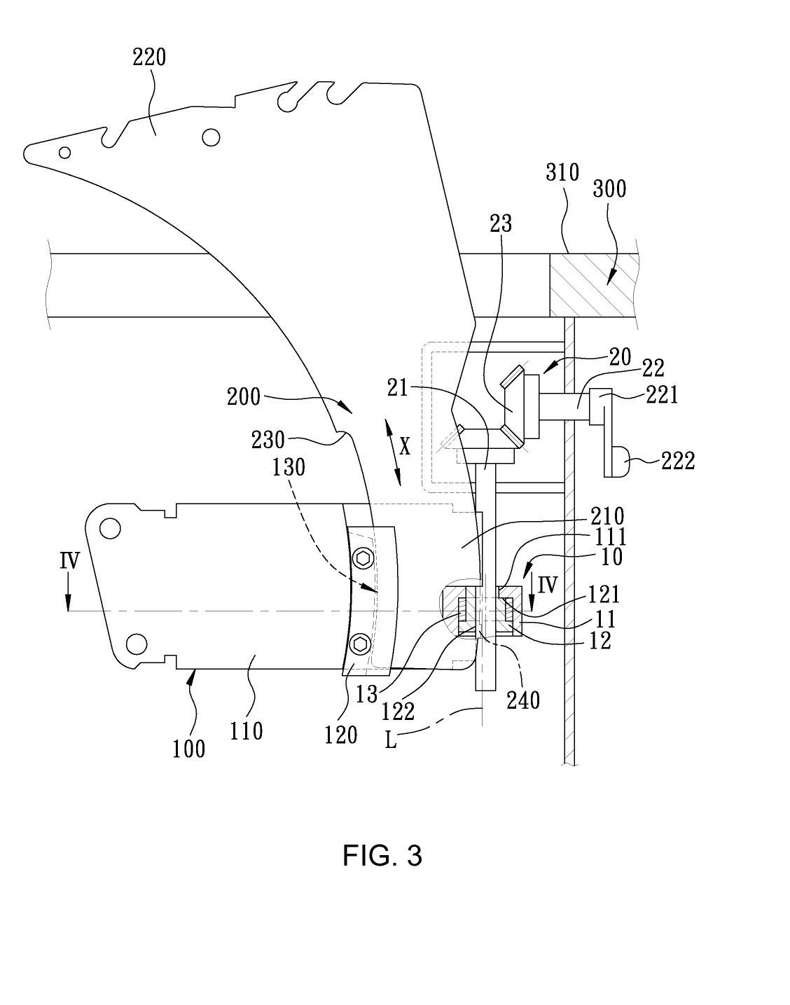

Referring to FIGS. 3 and 4, when the riving knife body 220 of the riving knife 200 protrudes over the top wall 310 of the machine base 300 and reaches an upper limit position (the highest position), the lower limit stop 240 is retained in position relative to the locking member 13 of the locking unit 10 by engagement of the lower limit stop 240 with the retaining portion 132. At this time, the operating member 20 can be manipulated (rotated) to drive the eccentrically disposed cylindrical brake portion 121 to move (rotate) the collar 131 of the locking member 13 into a locking position where the retaining portion 132 of the locking member 13 is also forced into engagement with the coupling portion 210 of the riving knife 200, thereby locking the riving knife 200 to the machine base 300 and in a fixed position relative thereto.

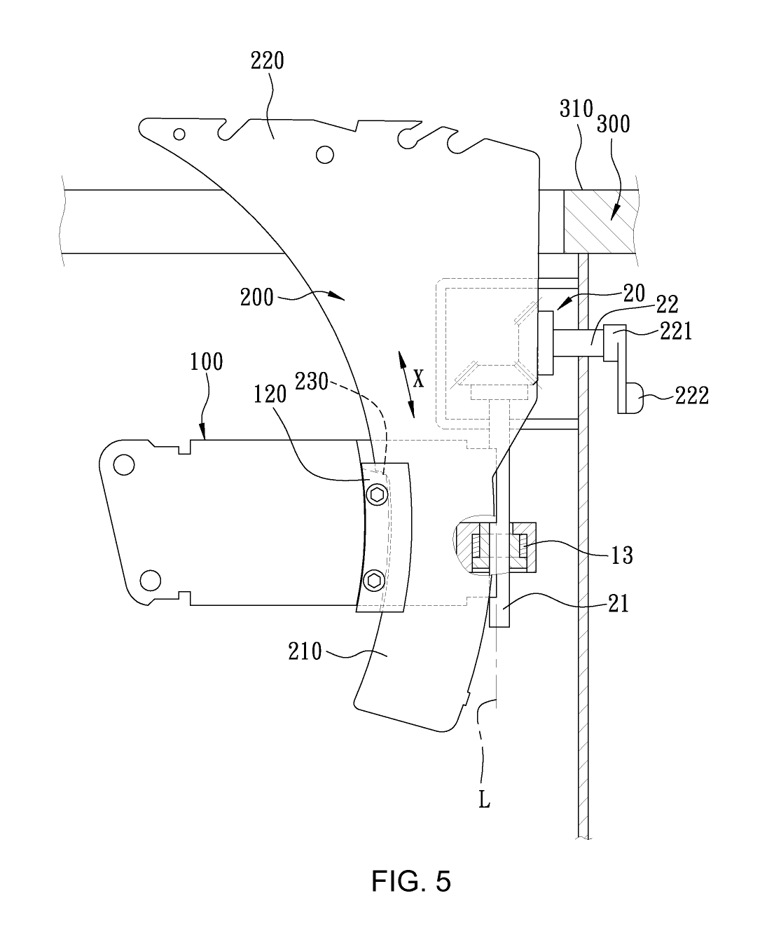

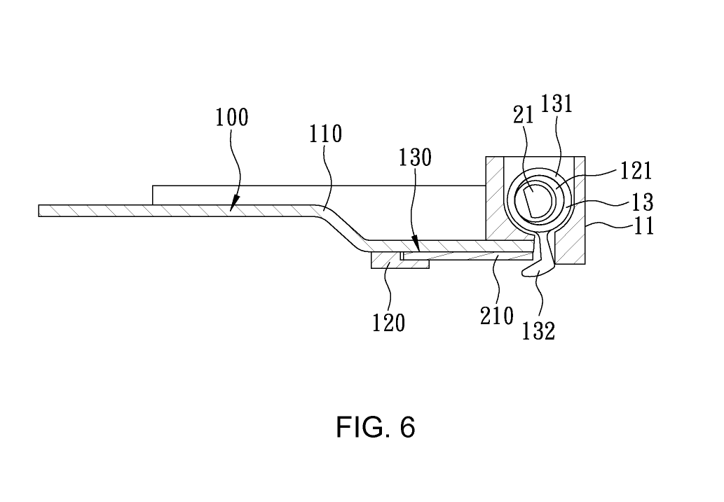

In order to adjust, detach, or replace the riving knife 200, as shown in FIGS. 5 and 6, the grip 225 of the operating member 20 can be manipulated to rotate the second shaft 22 and to further rotate the brake 12 about the axis L relative to the axle holder 11 by transmission of movement through the transmission gear set 23 and the first shaft 21.

At this time, as shown in FIG. 6, the cylindrical brake portion 121 of the brake 12 causes an opposite rotation of the collar 131 of the locking member 13, thus moving the retaining portion 132 away from the coupling portion 210 of the riving knife 200 to an unlocking position.

After disengagement of the retaining portion 132 from the coupling portion 210, the user can push down on the top edge of the riving knife body 220 to move the coupling portion 210 downwards along the longitudinal direction X to the lower limit position (the lowest position) where the upper limit stop 230 of the coupling portion 220 engages and is stopped against the top edge of the limiter block 120 of the locating member 100. Thus, the riving knife body 220 is disposed in the lowest position relative to the top wall 310. Of course, the riving knife 200 can be adjusted to any position between the upper and lower limits.

After adjustment of the position of the riving knife 200, the user can move the grip 222 in the opposite direction to return the locking member 13 to the locking position, as shown in FIG. 4.

Thus, the disclosed embodiment provides the grip 222 of the operating member 20 for moving the locking member 13 between the locking position and the unlocking position, allowing the user to conveniently adjust the position of the riving knife 200. Further, the disclosed saw machine riving knife adjustment mechanism is quite simple.

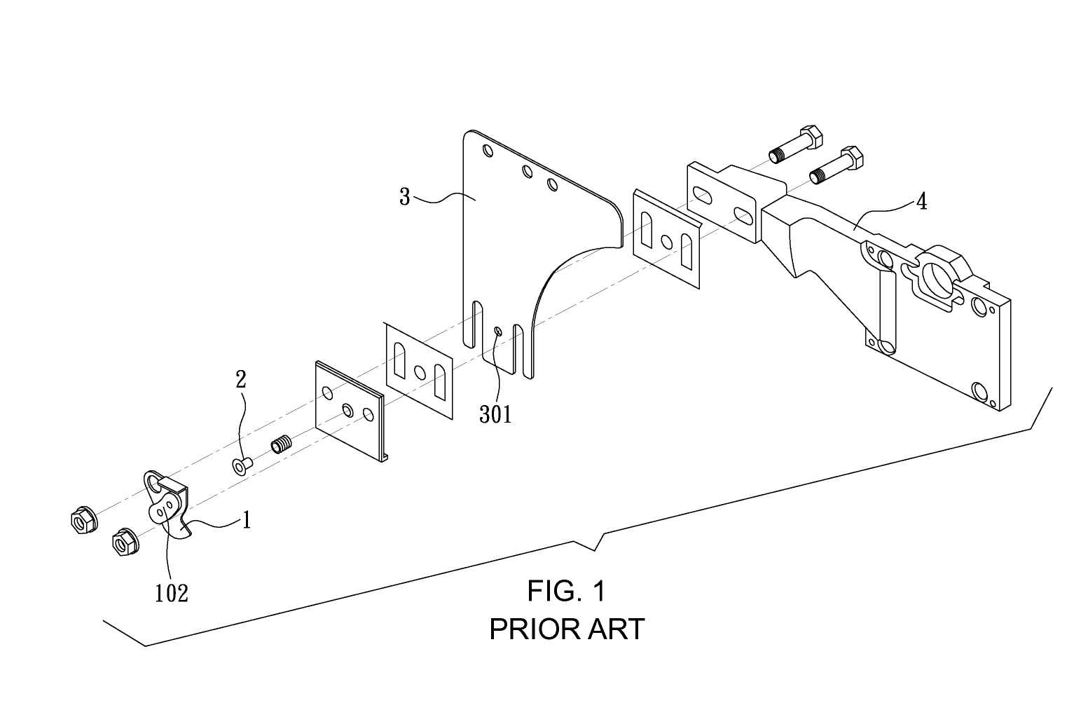

Further, by way of the arrangement of the first shaft 21, second shaft 22, transmission gear set 23, and grip 222 of the operating member 20, the grip 222 is suspended outside of the machine base 300 for operation by the user to move the locking member 13, thus moving the retaining portion 132 between the locking position and the unlocking position. Accordingly, the user does not to insert a hand into the inside of the machine base 300 and will also, therefore, not encounter any restriction in operating space when adjusting the position of the riving knife 200. When compared to the prior art design shown in FIG. 1, the operation of embodiments of a riving knife adjustment mechanism according to this disclosure is simple and easy.

During operation of the saw machine, the user may have to adjust the elevation of the saw blade (not shown) subject to changes of the thickness of the workpiece. When elevation of the saw blade is changed, the locating member 100 and the riving knife 200 can be moved with the saw blade, since the locating member 10 can be moved up and down along the first shaft 21 of the operating member 20. Further, the operating member 20 is rotatably mounted in a fixed location at the machine base 300 and is therefore not movable up and down with the locating member 100.

Thus, embodiments according to the present disclosure eliminate inconvenient riving knife 200 adjustment operations and other drawbacks of the prior art design shown in FIG. 1, in which the control plate 1 is mounted on the mounting frame 4 and the mounting frame 4 must be lifted to the upper limit position before adjustment of the riving knife 3 can be made in order to avoid the control plate 1 being moved deep inside of the machine base. According to the embodiments of the present disclosure, the operating portion 221 of the operating member 20 is constantly kept at a fixed location and will not be moved up and down with the locating member 100, thus simplifying adjustment of the position of the riving knife 200.

Further, the operating portion 221 and grip 222 of the operating member 20 are retained outside of the machine base 100, for convenient operation by the user to adjust the position of the riving knife 200 when desired.

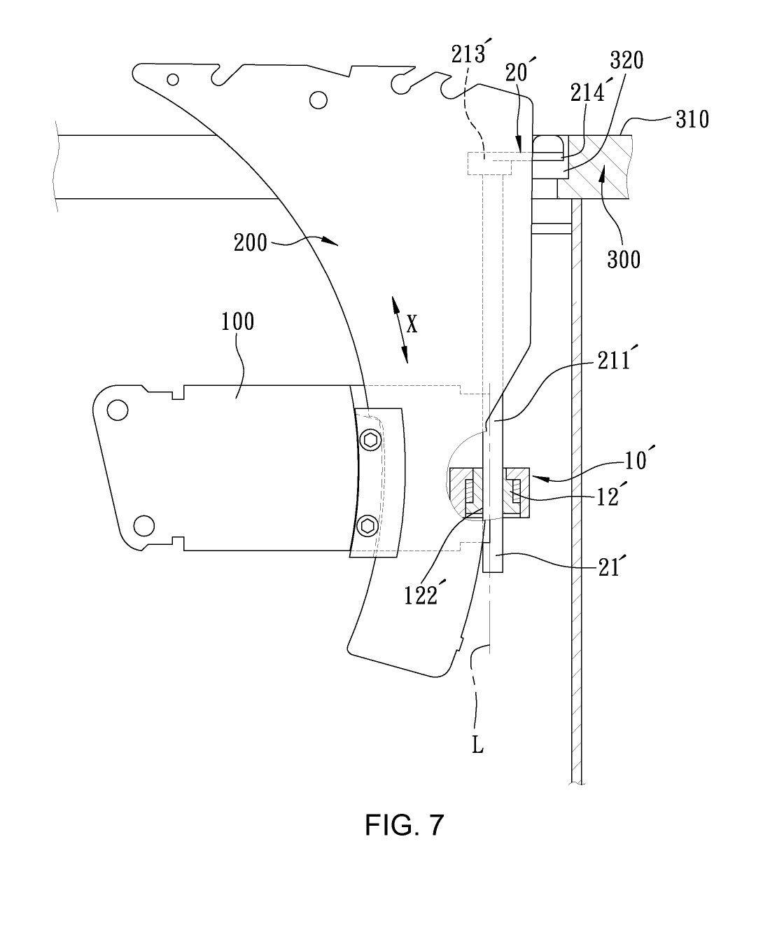

FIG. 7 illustrates a saw machine riving knife adjustment mechanism in accordance with a second embodiment of the present disclosure. The riving knife adjustment mechanism according to this second embodiment includes a locking unit 10′ and an operating member 20′.

This second embodiment is substantially similar to the aforesaid first embodiment with the exception that the machine base 300 includes a recessed hole 320 located on the top wall 310 thereof. The operating member 20′ includes a first shaft 21′ extending in a parallel manner relative to the axis L. The first shaft 21′ includes a coupling portion 211′ inserted into a noncircular coupling hole 122′of a brake 12′ (corresponding to the coupling hole 122 in the brake 12 of the embodiment of FIGS. 2-6), an operating portion 213′ and a grip 214′. The operating portion 213′ and the grip 214′ are accommodated in the recessed hole 320 below the elevation of the top wall 310. Rotating the grip 214′ causes the brake 12′ of the locking unit 10′ to be moved, thereby locking or unlocking the riving knife 200.

Although particular embodiments of the disclosure have been described in detail for purposes of illustration, various modifications and enhancements may be made without departing from the spirit and scope of the disclosure. Accordingly, the disclosure is not to be limited except as by the appended claims.

What is claimed is:

1. A riving knife adjustment mechanism mounted with a locating member to hold a riving knife in a machine base of a saw machine having a top wall, the riving knife adjustment mechanism comprising:
a locking unit disposed below said top wall of said machine base and installed on said locating member, and having a locking member rotatable to lock or release said riving knife, said locking member including a coupling mechanism disposed inside said machine base; and
an operating member having a connection portion coupled to the coupling mechanism of said locking member and an operating portion extending from said connection portion and suspended outside of said machine base.

2. The riving knife adjustment mechanism according to claim 1, wherein said coupling mechanism of said locking member is a non-circular coupling hole; and said connection portion of said operating member has a non-circular cross section fitting the non-circular coupling hole of said coupling mechanism.

3. The riving knife adjustment mechanism according to claim 2, wherein said locking unit comprises an axle holder affixed to said locating member, and a brake axially mounted in said axle holder, said axle holder comprising an axle hole extending therethrough along an axis, said brake being movably mounted in said axle hole and including a brake portion disposed in an eccentric relationship relative to said axle hole; said coupling hole located on said brake; said locking member having a retaining portion extending through an opening in communication with said axle hole for securing said riving knife, said operating member adapted to drive said brake to move said locking member between a locking position, where said retaining portion locks said riving knife to said locating member, and an unlocking position, where said retaining portion is disengaged from said riving knife for allowing movement of said riving knife relative to said locating member.

4. The riving knife adjustment mechanism according to claim 3, wherein said locking member further comprises a collar connected to one end of said retaining portion and arranged on said brake, which further comprises a first end portion located on a first end of said brake portion, and axially inserted into said axle hole, a second end portion located on an opposed second end of said brake portion, and axially inserted into said axle hole, and a shoulder connected between said brake portion and said second end portion and adapted for the blocking said collar; said coupling hole is a through hole extending through said first end portion and said second end portion.

5. The riving knife adjustment mechanism according to claim 4, wherein said operating member further comprises first and second shafts, said first shaft defining said connection portion, said second shaft being operatively connected to a first end of said first shaft at a right angle thereto, said second shaft comprising an operating portion extending out of said machine base and terminating in a grip.

6. The riving knife adjustment mechanism according to claim 5, wherein said operating member further comprises a transmission gear set coupled between said first and second shafts.

7. The riving knife adjustment mechanism according to claim 6, wherein said second shaft is axially mounted in said machine base; wherein said locating member, said riving knife and the axle holder, brake and locking member of said locking unit are all movable along said first shaft of said operating member.

8. The riving knife adjustment mechanism according to claim 1, wherein said operating member further comprises first and second shafts, said first shaft defining said connection portion, said second shaft being operatively connected to a first end of said first shaft at a right angle thereto, said second shaft comprising an operating portion extending out of said machine base and terminating in a grip.

9. The riving knife adjustment mechanism according to claim 1, wherein said operating member further comprises a first shaft; said connection portion is located on a bottom side of said first shaft; and said operating portion is located on a top side of said first shaft corresponding to the top wall of said machine base and terminating in a grip.

10. The riving knife adjustment mechanism according to claim 9, wherein said machine base comprises a recessed hole adapted for accommodating said operating portion and said grip.
